(19) United States
(12) Patent Application Publication
(10) Pub. No.: US 2005/0112447 A1
(43) Pub. Date: May 26, 2005

(54) Electrode for the reduction of polysulfide species

(76) Inventors: Stephen Fletcher, Loughborough (GB); Nicholas Joseph van Dijk, Leicester (GB)

Correspondence Address: Antonelli Terry Stout & Kraus, 1300 North Seventeenth Street, Suite 1800, Arlington, VA, 22209, US

(21) Appl. No.: 10/508,614

(22) PCT Filed: Mar. 26, 2003
(86) PCT No.: PCT/GB03/01316

(30) Foreign Application Priority Data
Mar. 27, 2002 (GB) 0207214.8

(51) Int. Cl. H01M 4/90; H01M 8/20

(52) U.S. Cl. 429/40; 429/105; 429/210

(57) ABSTRACT

An electrode which incorporates therein a catalyst for the reduction of polysulfide species, which catalyst comprises at least one organic complex of a transition metal. Preferred catalysts for incorporation into the electrodes are cobalt (II) phthalocyanine, cobalt (II) bis (salicylaldehyde), or mixtures thereof.

The present invention relates to an electrode which incorporates a catalyst for lowering the reduction overpotential of polysulfide species and, in particular, to an electrode which incorporates a catalyst for the sulfide/polysulfide redox reduction reaction.

This reaction is described, for example, in U.S. Pat. No. 4,485,154. Typical cells in which this reduction reaction is carried out are known as regenerative fuel cells in which the chemical fuels are regenerated by reversing the current flow.

To maximise the energy efficiency of regenerative fuel cells it is necessary to perform the oxidation and reduction reactions of the fuels as closely as possible to their electrochemical reversible potentials. Any inefficiencies manifest as additional potentials called overpotentials. Not surprisingly, it is an object of much research in fuel cells to minimise overpotentials. One way to minimize overpotentials is by incorporating catalysts in the electrode materials.

In carrying out the sulfide/polysulfide redox reduction reaction the current density at an electrode carrying out this reaction is limited by the combined effects of restricted mass transport and slow electrochemical reaction kinetics. Many authors (Lessner, P. M., McLaron, F. R., Winnick, J. and Cairns, E. J., J. Appl. Electrochem., 22. (1996) 927-934, Idem., ibid. 133 (1986) 2517) have utilized a high surface area electrode (e.g. an expanded metal mesh) to overcome these effects by providing a high interfacial area per unit volume. The same authors have utilized Ni, Co or Mo metals, or the sulfides of these metals, to catalyse the electrode reaction. However, metal sulfides have a tendency to dissolve.

In WO 00/44058 the use of an electron mediator (“electrocatalyst”) is described which is included in suspension in the solution in the negative chamber for the sulfide/polysulfide reaction, the mediator having a particle size of up to 1 micrometre in diameter and preferably comprising copper, nickel, iron, cobalt or molybdenum, or a salt of copper, nickel, iron, cobalt or molybdenum. Typically the salt is a sulfide.

Although the use of a colloidal mediator enhances the observed current, the mediator particles circulate freely in the negative chamber and may have a detrimental effect upon other components of the cell.

In the present invention we have developed a means of decreasing the overpotential of the sulfide/polysulfide redox reaction by immobilizing one or more complexes of metal ions in or on the electrode material which then remain substantially undissolved.

Accordingly, the present invention provides an electrode which incorporates a catalyst for the reduction of polysulfide species, which catalyst comprises at least one organic complex of a transition metal.

These organic complexes of transition metals may be adsorbed on electrode surfaces by evaporation of various non-aqueous solutions, or may be deposited by precipitation, or may be deposited by vapour deposition, or may be incorporated directly as solids. The electrodes may be made of metal, activated carbon, or any other form of carbon, or any other conducting material.

Preferred transition metal complexes for use in the present invention are those of manganese, iron, cobalt, nickel or copper, the organic complexes of cobalt being particularly preferred.

Suitable organic complexes are those formed with phthalocyanine, bis(salicylaldehyde), bis(salicylidene)-1,2-phenyldiamine, bis(salicylidene)-ethylenediamine, bis(salicylideiminato-3-propyl)-methylamine and 5,10,15,20-tetraphenyl-21H,23H-porphine.

Particularly preferred catalysts are the organic complexes of cobalt and in particular cobalt (II) phthalocyanine, cobalt (II) bis(salicylaldehyde), or a mixture thereof.

The sulfide/polysulfide redox-reduction reaction takes place in the negative chamber of an electrochemical cell during energy storage. The sulfide contained in the solution in the negative chamber may be one or more of sodium, potassium, lithium or ammonium sulfide and may preferably be present in a concentration of from 1 to 2M. The electrochemical cell is completed by adding a different redox couple to the positive chamber. For example, this may be the bromine/bromide couple.

The different redox couples circulate independently and are kept apart by a membrane permeable to monovalent cations, typically made of Nafion™. The latter is a commercially available perfluorosulfonate membrane material manufactured by E I Dupont de Nemours & Co. (Wilmington, Del.). Nafion™ membranes have acceptable ionic conductivity, and good long-term mechanical and chemical stability. They are manufactured with thicknesses in the range 25-183 μm, and have specific conductances of approximately 0.01 S/cm in concentrated sodium polysulfide solutions at 25° C., provided divalent cations are excluded from the electrolyte solution. Structurally, Nafion™ is a co-polymer comprising backbone units of hydrophobic tetrafluoroethylene, and side chains of perfluorinated vinyl ether terminated by hydrophilic sulfonate groups. Membranes from other companies can also be used provided their structures permit the transport of cations ions rapidly and selectively from one side of the cell to the other. Examples are Aciplex™ (Asahi Chemical Industry Co. Ltd/Japan) and Flemion™ (Asahi Glass Co. Ltd/Japan),

The equilibrium cell voltage is about 1.5 V. when the bromine/bromide redox couple is placed in the positive chamber of the electrochemical cell. This forms a so-called “regenerative fuel cell”. During discharge, and depending upon-electrode surface area, the voltage of each regenerative fuel cell may fall to 1.3 V. During recharge, and depending upon electrode surface area, the voltage of each regenerative fuel cell may rise to 1.9 V. A significant fraction of this latter voltage is traceable to the slow speed of reduction of various polysulfide species. The present invention provides a means of speeding up the reduction of these polysulfide species, and thus provides a means of decreasing the overpotential of recharge. Since the energy losses of fuel cells (which appear as heat) are directly proportional to the overpotentials of charge and recharge, decreasing the overpotential of recharge results in a significant cost saving.

Preferably the electrodes are bipolar electrodes, the negative surface of which forms the electrode of the invention.

The present invention also includes within its scope an electrochemical apparatus which comprises a single cell or an array of cells, each cell with a positive chamber containing a positive electrode and an electrolyte solution and a negative chamber containing a negative electrode and an electrolyte solution containing sulfide, the positive and negative chambers being separated from one another by a cation exchange membrane and the negative electrode being an electrode as hereinbefore described.

The present invention still further includes within its scope the use of an electrode as defined herein in a process for the electrochemical reduction of sulphur species.

The present invention will be further described with reference to the accompany drawings, in which:

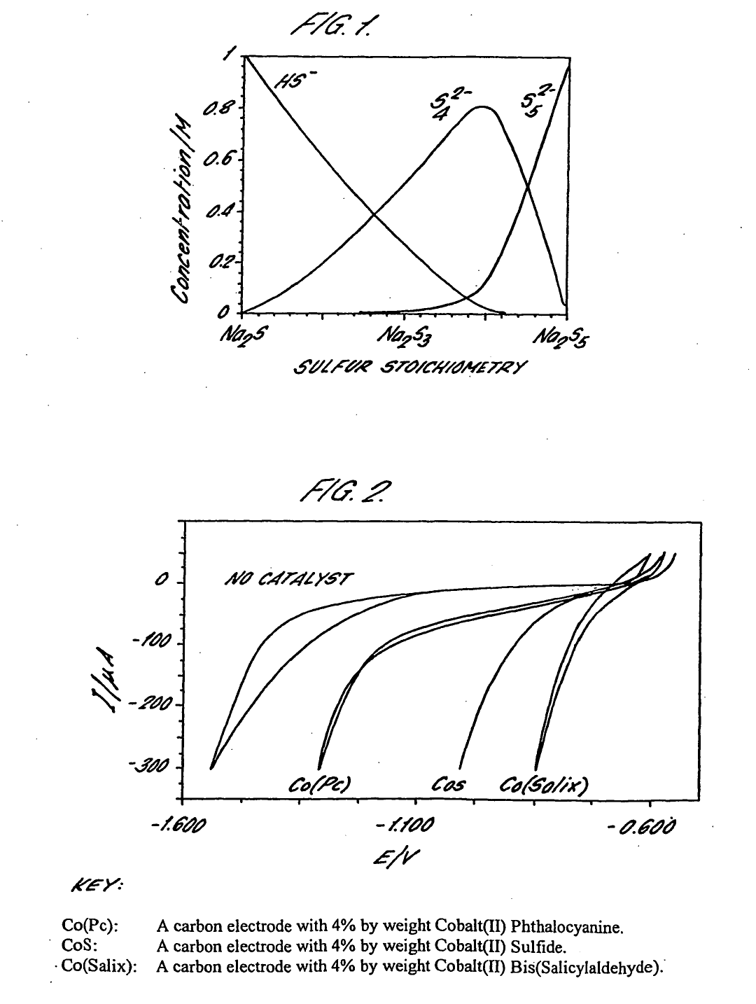

FIG. 1 illustrates the sulfur stoichiometry for sodium polysulfide species;

FIG. 2 illustrates a voltammogram in an Na₂S_{3.4} solution where S₄²⁻ is the predominant species (Example 5);

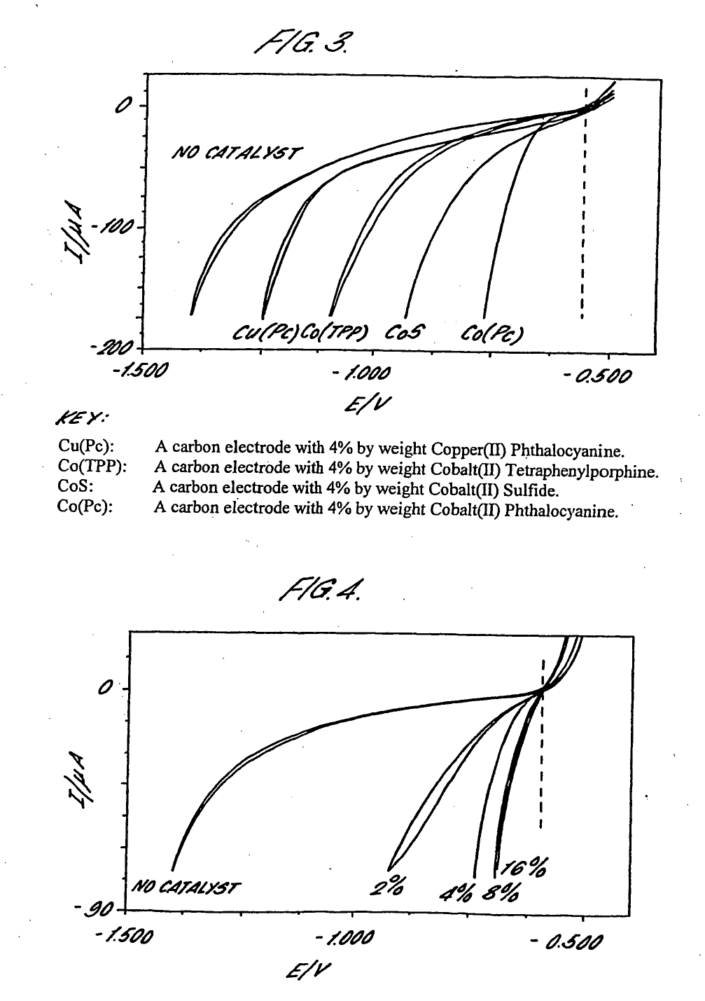

FIG. 3 illustrates a voltammogram in a Na₂S_{4.6} solution where S₅²⁻ is the predominant species (Example 6); and

FIG. 4 illustrates the effect of catalyst concentration on voltammograms in an Na₂S_{4.6} solution where S₅²⁻ is the predominant species (Example 7).

Referring to FIG. 1, it is well known to those skilled in the art that different polysulfide species dominate in different concentration ranges of total dissolved sulfur. The general formula of the sodium polysulfide solutions used in the present work is Na₂Sₙ, where 1≦n≦5, and we refer to n as the sulfur stoichiometry. As shown in FIG. 1, below a sulfur stoichiometry of 4.45 the predominant reducible ion is S₄²⁻, whereas above a sulfur stoichiometry of 4.45 the predominant reducible ion is S₅²⁻. Above a sulfur stoichiometry of approximately 4.8 colloidal sulfur is unavoidably present, which prevents the preparation of pure S₅²⁻ solutions.

The present invention will be further described with reference to the following Examples. In these Examples the term “ink” is used to mean a fine suspension of particles in an evaporable solvent which is suitable for printing.

### EXAMPLE 1

In this example the construction of a working electrode containing cobalt(II) phthalocyanine in a 2% w/w catalyst-to-carbon loading is described.

To 51.2 mg of finely ground cobalt(II) phthalocyanine, there were added 2 drops of isophorone, which were mixed to form a viscous slurry. To this was added 6.4 g of proprietary carbon ink (Ercon Inc, West Wareham, Mass.) that contained 40% by weight carbon. After thorough mixing, the resulting paste was screen-printed onto a polyester support, through a stainless steel screen with a mesh count of 80 strands per centimetre, to create the working electrode. After oven drying the working electrode at 120° C. for one hour, a layer of proprietary insulator (Ercon Inc, West Wareham, Mass.) was screen printed over the carbon, through a stainless steel screen with a mesh count of 112 strands per centimetre, to decrease the electrode size to a 3 mm diameter disk. The insulator was then cured at 120° C. for one hour.

### EXAMPLE 2

In this example the construction of a working electrode containing Cobalt(II) Phthalocyanine in a 4% w/w catalyst-to-carbon loading is described.

To 102.9 mg of finely ground cobalt(II) phthalocyanine, there were added 2 drops of isophorone, which were mixed to form a viscous slurry. To this was added 6.4 g of proprietary carbon ink (Ercon Inc, West Wareham, Mass.) that contained 40% by weight carbon. After thorough mixing, the resulting paste was screen-printed onto a polyester support, through a stainless steel screen with a mesh count of 80 strands per centimetre, to create the working electrode. After oven drying the working electrode at 120° C. for one hour, a layer of proprietary insulator (Ercon Inc, West Wareham, Mass.) was screen printed over the carbon, through a stainless steel screen with a mesh count of 112 strands per centimetre, to decrease the electrode size to a 3 mm diameter disk. The insulator was then cured at 120° C. for one hour.

### EXAMPLE 3

Electrodes containing 8% and 16% w/w catalyst-to-carbon loading were prepared according to the method of Example 2 by increasing the amounts of cobalt(II) phthalocyanine.

### EXAMPLE 4 (CONTROL)

A control electrode containing no catalyst was also constructed. To 6.0 g of proprietary carbon ink (Ercon Inc, West Wareham, Mass.) were added 2 drops of isophorone, to form a consistent paste. After thorough mixing, this was screen printed onto an inert polyester support, through a stainless steel screen with a mesh count of 80 strands per centimetre, to create the working electrode. After oven drying the working electrode at 120° C. for one hour, a layer of proprietary insulator (Ercon Inc, West Wareham, Mass.) was screen printed over the carbon, through a stainless steel screen with a mesh count of 112 strands per centimetre, to decrease the electrode size to a 3 mm diameter disk. The insulator was then cured at 120° C. for one hour.

### EXAMPLE 5

This example describes the testing procedure for catalysts for the reduction of S₄²⁻.

The screen-printed working electrode as described in Example 2 was placed in a cell containing 100 mL of solution, in such a way that the disk electrode was fully immersed. The solution, consisting of 1 M Na₂S_{3.4} and 1 M NaBr in water, was thermostatted at 25° C. The electrode was voltammetrically cycled at 10 mV s⁻¹, with the first ten voltammograms being recorded. FIG. 2 illustrates the effectiveness of various catalysts (third cycle shown).

For each catalyst eight replicate electrodes were prepared and tested. Overpotentials were measured at −0.160 mA (corresponding to 2.25 mA cm⁻²) and are listed in Table 1. It is evident that various different compounds of transition metals exert catalytic effects on the reduction of S₄²⁻.

TABLE 1
Compilation of overpotentials (±10 mV) for different
catalysts at 4% loading, in Na₂S_{3.4} solutions, where S₄²⁻ is
the predominant ion. The lowest overpotentials indicate the
best catalysts. Median values, eight replicates.

| | Overpotential/mV @ |
|---|---|
| Catalyst | 2.25 mA cm⁻² |
| Cobalt(II) Bis(salicylaldehyde) | −144 |
| Cobalt(II) Sulfide | −298 |
| Iron(II) Phthalocyanine | −350 |
| Bis(salicylidene)-1,2- | −393 |
| phenylenediamino-Cobalt(II) | |
| Bis(salicylidene)- | −480 |
| ethylenediamino-Cobalt(II) | |
| Vitamin B₁₂ (cyanocobalamin) | −552 |
| Cobalt(II) Phthalocyanine | −571 |
| 5,10,15,20-tetraphenyl-21H,23H- | −606 |
| porphine Cobalt(II) | |
| Bis(salicylideniminato-3- | −780 |
| propyl)-methylamino-Cobalt(II) | |
| Manganese(II) Phthalocyanine | −813 |
| Nickel(II) Phthalocyanine | −813 |
| Copper(II) Phthalocyanine | −813 |
| No Catalyst | −813 |

### EXAMPLE 6

This example describes the testing procedure for catalysts for the reduction of S₅²⁻.

The screen-printed working electrode as described in Example 2 was placed in a cell containing 100 mL of solution, in such a way that the disk-shaped working electrode was fully immersed. The solution, consisting of 1 M Na₂S_{4.6} and 1 M NaBr in water, was thermostatted at 25° C. The electrode was voltammetrically cycled at 10 mV s⁻¹, with the first ten voltammograms being recorded. FIG. 3 illustrates the effectiveness of various catalysts (third cycle shown).

For each catalyst eight replicate electrodes were prepared and tested. Overpotentials were measured at −0.160 mA (corresponding to 2.25 mA cm⁻²) and are listed in Table 2. It is evident that various different compounds of transition metals exert catalytic effects on the reduction of S₅²⁻.

TABLE 2
Compilation of overpotentials (±10 mV) for different
catalysts at 4% loading, in Na₂S_{4.6} solution, where S₅²⁻ is the
predominant ion. The lowest overpotentials indicate the best
catalysts. Median values, eight replicates.

| | Overpotential/mV @ |
|---|---|
| Catalyst | 2.25 mA cm⁻² |
| Cobalt(II) Phthalocyanine | −194 |
| Manganese(II) Phthalocyanine | −237 |
| Cobalt(II) | |
| Bis(Salicylaldehyde) | −246 |
| Iron(II) Phthalocyanine | −357 |
| Cobalt(II) Sulfide | −378 |
| Bis(salicylidene)-1,2- | −393 |
| phenylenediamino-Cobalt(II) | |
| Vitamin B₁₂ (cyanocobalamin) | −400 |
| 5,10,15,20-tetraphenyl- | −530 |
| 21H,23H-porphine Cobalt(II) | |
| Bis(salicylidene)- | −559 |
| ethylenediamino-Cobalt(II) | |
| Copper(II) Phthalocyanine | −703 |
| Nickel(II) Phthalocyanine | −714 |
| Bis(salicylideniminato-3- | −715 |
| propyl)-methylamino- | |
| Cobalt(II) | |
| No Catalyst | −835 |

### EXAMPLE 7

In this example the effect of catalyst loading is described.

The screen printed working electrodes as described in Examples 1 to 4 were tested one at a time by being placed in a cell containing 100 mL of solution such that the disk-shaped working electrode was fully immersed. The solution, consisting of 1 M Na₂S_{4.6} and 1 M NaBr in water, was thermostatted at 25° C.

FIG. 4 illustrates the effect of using different cobalt phthalocyanine catalyst concentrations in the carbon electrodes (third cycle shown). The electrode was voltammetrically cycled at 10 mV s⁻¹, with the first ten voltammograms being recorded. For each measurement eight replicate electrodes were prepared and tested. It is evident that the maximum catalytic effect is achieved at about 8% loading by weight.

1. An electrode which incorporates therein a catalyst for the reduction of polysulfide species, which catalyst comprises at least one organic complex of a transition metal.

2. An electrode as claimed in claim 1 wherein the catalyst is an organic complex of manganese, iron, cobalt, nickel or copper.

3. An electrode as claimed in claim 2 wherein the organic complex is a complex of cobalt.

4. An electrode as claimed in claim 1 wherein the catalyst comprises cobalt (II) phthalocyanine, cobalt (II)bis(salicylaldehyde) or a mixture thereof.

5. An electrode as claimed in claim 1 which is a bipolar electrode.

6. An electrochemical apparatus which comprises a single cell or an array of cells, each cell with a positive chamber containing a positive electrode and an electrolyte solution and a negative chamber containing a negative electrode and an electrolyte solution containing sulfide, the positive and negative chambers being separated from one another by a cation exchange membrane and the negative electrode being an electrode as claimed in claim 1.

7. An electrochemical apparatus as claimed in claim 6 which is an apparatus for energy storage and/or power delivery.

8. A process the electrochemical reduction of sulfur species, comprising electrochemically reducing a sulfur species on an electrode according to claim 1.

9. A process for electrochemical energy storage which comprises carrying out a sulfide/polysulfide redox reduction reaction on an electrode according to claim 1.

10. An electrode as claimed in claim 3 wherein the catalyst comprises cobalt (II) phthalocyanine, cobalt (II)bis(salicylaldehyde) or a mixture thereof.

11. An electrode as claimed in claim 2 which is a bipolar electrode.

12. An electrode as claimed in claim 3 which is a bipolar electrode.

13. An electrode as claimed in claim 4 which is a bipolar electrode.
